(19) United States
(12) Patent Application Publication
(10) Pub. No.: US 2020/0148019 A1
(43) Pub. Date: May 14, 2020

(54) Driven Steerable Suspension System For A Vehicle

(71) Applicant: AxleTech International IP Holdings, LLC., Troy, MI (US)

(72) Inventors: James Michael McConville, Hamtramck, MI (US); Timothy Matthew Webb, Rochester Hills, MI (US); Frank Robert Porzondek, Macomb, MI (US); Vivien Benjamin Julien Fabien Boillot, Noidans-lès-Vesoul (FR)

(73) Assignee: Axle Tech International IP Holdings, LLC., Troy, MI (US)

(21) Appl. No.: 16/615,482

(22) PCT Filed: May 22, 2018
(86) PCT No.: PCT/US18/33867

§ 371 Date: Nov. 21, 2019

Related U.S. Application Data
(60) Provisional application No. 62/509,401, filed on May 22, 2017.

(51) Int. Cl. B60G 3/20; B60G 7/02; B62D 7/18

(52) U.S. Cl. CPC B60G 3/20; B60G 7/02; B62D 7/18; B60G 2204/128; B60G 2200/144; B60G 2204/143; B60G 2200/44; B60G 2206/50

(57) ABSTRACT

A driven steerable suspension system is mounted to each of a vehicle frame and a pair of wheels of a vehicle. The system includes a subframe including first and second flanks for mounting along the vehicle frame. The system includes first and second suspension assemblies coupled to the first and second flanks, respectively. Each of the assemblies include a lower control arm extending between lower inboard and outboard joints, and an upper control arm extending between upper inboard and outboard joints. Each of the assemblies include a steering knuckle pivotally coupled to the lower outboard joint and the upper outboard joints. Each of the assemblies include a wheel hub rotatably coupled to the steering knuckle. Each of the assemblies include a dampened biasing member pivotally mounted to the subframe and the lower control arm. Each of the assemblies include a drive axle rotatably coupled with the wheel hub.

### 1. FIELD OF THE INVENTION

The present disclosure relates to a driven steerable suspension system for a vehicle.

### 2. DESCRIPTION OF RELATED ART

Suspension assemblies are used in vehicles having wheels, such as passenger cars, trucks, mass transit vehicles such as city and/or commercial buses, agricultural vehicles, semi-trucks, trailers, and/or the like. The suspension assembly allows for movement of the wheels independent of the chassis of the vehicle to prevent variations in the road surface from being directly transmitted to the chassis of the vehicle. Often, large vehicles have a chassis with frame rails for supporting heavy loads. These large vehicles often incorporate a suspension assembly mounted below the frame rails.

Although effective in allowing movement of the wheels independent of the chassis, the mass of the chassis is on top of the suspension assembly, which results in a high center of gravity that is susceptible to roll and decreased handling performance. As such, there remains a need to provide an improved suspension assembly for a vehicle.

### SUMMARY OF THE INVENTION AND ADVANTAGES

The subject invention provides for a driven steerable suspension system for a vehicle. The driven steerable suspension system is mounted to each of a vehicle frame of the vehicle and a pair of wheels of the vehicle.

The driven steerable suspension system includes a subframe. The subframe includes a first flank and a second flank spaced from the first flank. Each of the first and second flanks extend in a substantially planar configuration along a longitudinal axis substantially parallel to one another for mounting along opposing outboard sides of the vehicle frame.

The driven steerable suspension system further includes a first suspension assembly coupled to the first flank of the subframe and a second suspension assembly spaced from the first suspension assembly and coupled to the second flank of the subframe.

Each of the first and second suspension assemblies include a lower control arm extending between at least one lower inboard joint and a lower outboard joint, and an upper control arm spaced from the lower control arm and extending between at least one upper inboard joint and an upper outboard joint.

Each of the first and second suspension assemblies further include a steering knuckle extending between and pivotally coupled to the lower outboard joint of the lower control arm and the upper outboard joint of the upper control arm along a steering axis transverse to the longitudinal axis. The steering knuckle is rotatable about the steering axis for turning one of the pair of wheels.

Each of the first and second suspension assemblies further include a wheel hub rotatably coupled to the steering knuckle along about a wheel axis for rotatably supporting one of the pair of wheels. The wheel axis intersects the steering axis. Furthermore, each of the first and second suspension assemblies include a dampened biasing member extending between a first end pivotally mounted to the subframe and a second end pivotally mounted to the lower control arm. Each of the first and second suspension assemblies include a drive axle extending along a drive axis and rotatably coupled with the wheel hub for rotating the wheel. The second end of the dampened biasing member is mounted to the lower control arm spaced from the drive axis to prevent contact between the drive axle and the dampened biasing member. The first end of the dampened biasing member is disposed above the at least one lower inboard joint of the lower control arm.

Accordingly, the driven steerable suspension system provides the advantage of evenly distributing forces from the first and second suspension assemblies to the first and second flanks and to the vehicle frame to reduce stress points on the vehicle frame. Furthermore, the pivotal mounting of the at least one upper inboard joint of the upper control arm of each of the first and second suspension assemblies to the outer surface of the first and second flanks aligns the vehicle frame between the pair of wheels. The alignment of the vehicle frame between the pair of upper control arms allows the lowering of the ride height of the vehicle. The lowering of the ride height of the vehicle lowers the center of gravity of the vehicle, which reduces vehicle roll and improves vehicle handling.

### BRIEF DESCRIPTION OF THE DRAWINGS

Advantages of the subject invention will be readily appreciated as the same becomes better understood by reference to the following detailed description when considered in connection with the accompanying drawings.

FIG. 1 is a first perspective view of a driven steerable suspension system.

FIG. 2 is a second perspective view of the driven steerable suspension system.

FIG. 3 is a front elevational view of the driven steerable suspension system.

FIG. 4 is a top elevational view of the driven steerable suspension system.

FIG. 5 is a rear elevational view of the driven steerable suspension system.

FIG. 6 is a bottom elevational view of the driven steerable suspension system.

FIG. 7 is a left side elevational view of the driven steerable suspension system.

FIG. 8 is a right side elevational view of the driven steerable suspension system.

FIG. 9 is a cross-sectional view of a first suspension assembly of the driven steerable suspension system.

FIG. 10 is a cross-sectional perspective view of the first suspension assembly of the driven steerable suspension system.

### DETAILED DESCRIPTION OF THE INVENTION

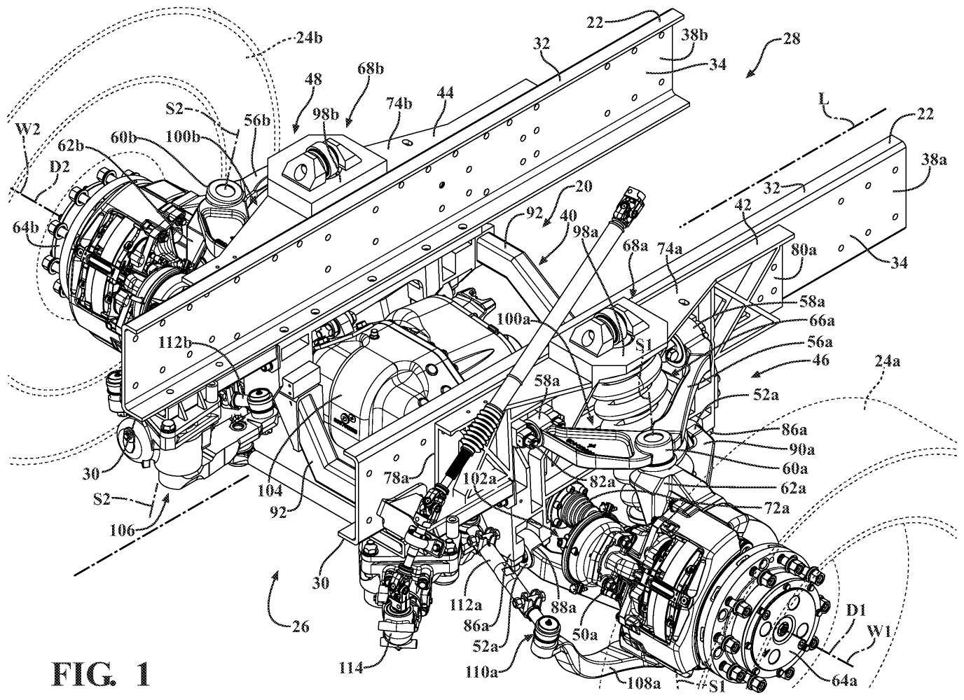

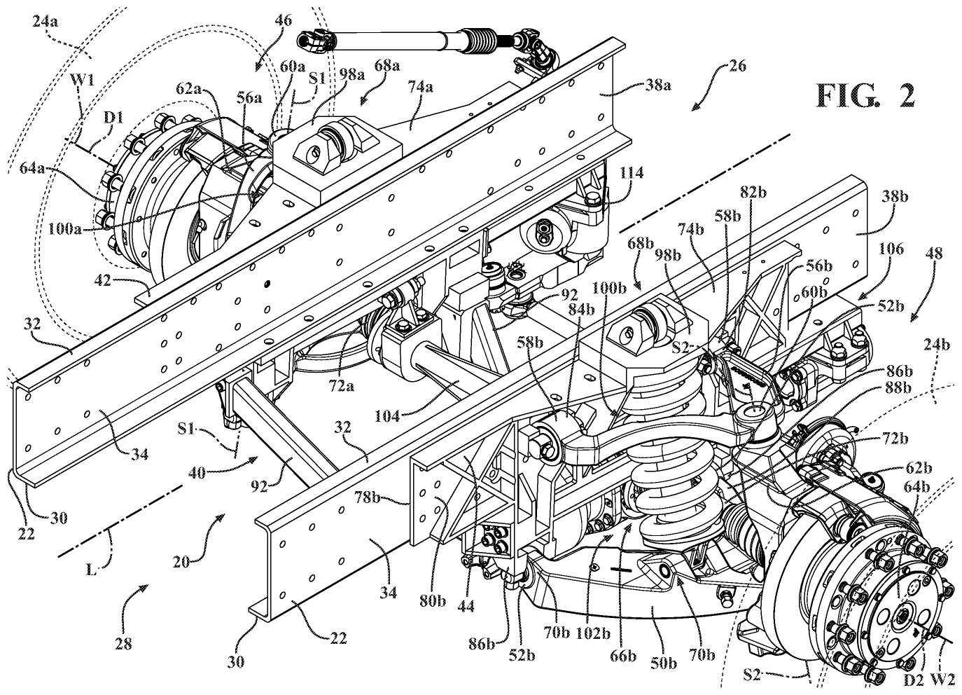

Referring to the Figures, wherein like numerals indicates like or corresponding parts throughout the several views; a driven steerable suspension system 20 for a vehicle is generally shown in FIGS. 1 and 2. The vehicle provides transportation along a road surface. Non-limiting examples of the vehicle include a mass transit vehicle (such as a city bus, a commercial bus, a trolley vehicle, etc.), a school bus, a commercial semi-truck and associated trailers, an agricultural vehicle, a passenger car or truck, crash fire rescue truck and/or the like. The vehicles that the driven steerable suspension system 20 are typically used on are medium duty and higher trucks (i.e., US Truck Class 4 and higher); however, one having skill in the art will appreciate that the driven steerable suspension system 20 may be used on any other suitable vehicle.

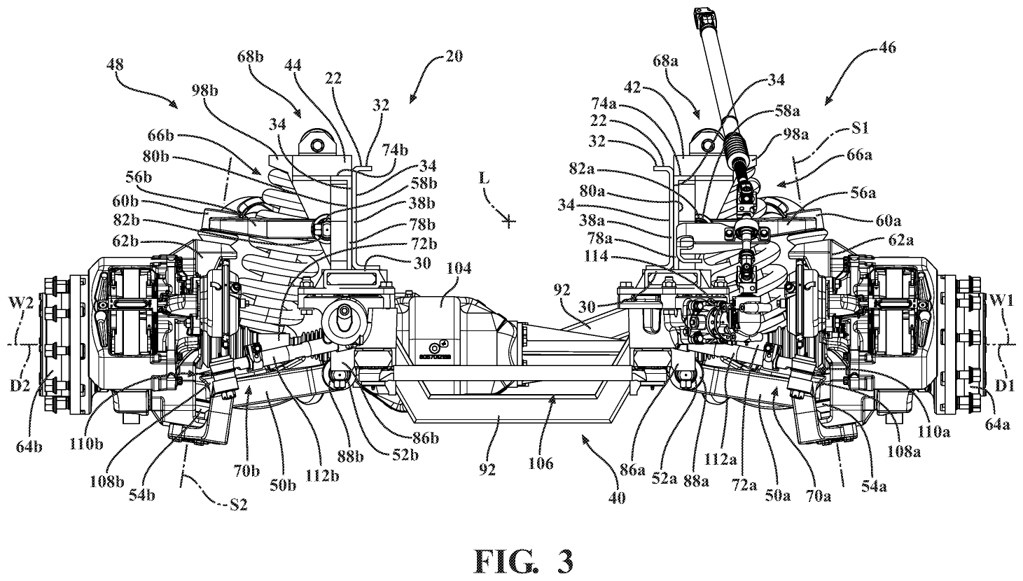

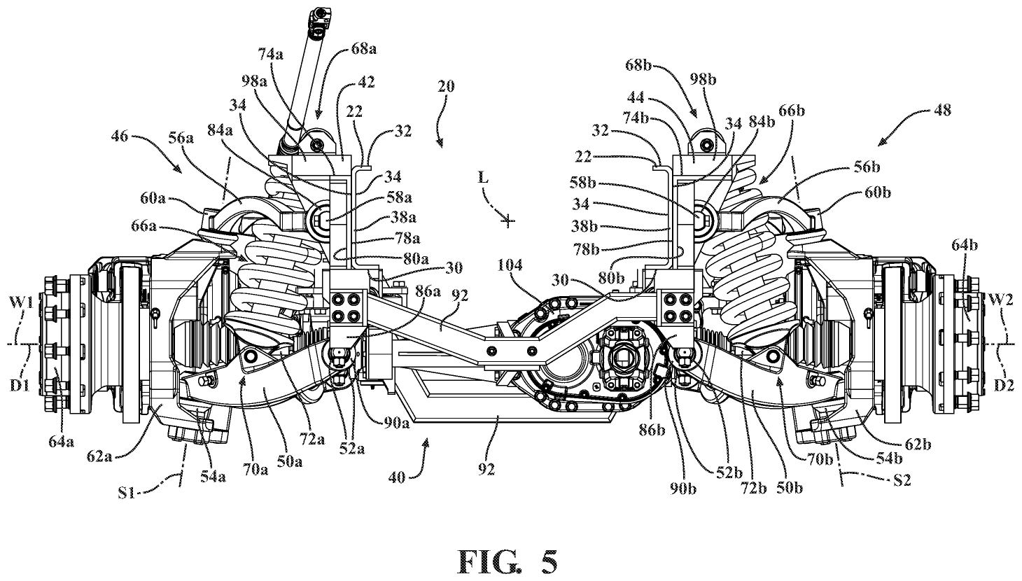

The driven steerable suspension system 20 is mounted to each of a vehicle frame 22 of the vehicle and a pair of wheels 24 of the vehicle. As shown in FIGS. 1 and 2, the vehicle frame 22 extends longitudinally along the vehicle between a front end 26 and a rear end 28 of the vehicle. The vehicle frame 22 may support a vehicle body, which at least partially encloses the vehicle to protect contents therein (such as occupants, goods, etc.) As shown in FIGS. 3 and 5, the vehicle frame 22 has a bottom surface 30 configured to face the road surface and a top surface 32 opposite the bottom surface 30 and configured to face away from the road surface. The vehicle frame 22 also has a pair of side surfaces 34 extending between the bottom and top surfaces 30, 32. The vehicle frame 22 may include a pair of frame rails 38a, 38b, with each of the frame rails 38a, 38b having the top surface 32, the bottom surface 30, and the pair of side surfaces 34. One having skill in the art will appreciate that the vehicle may have any number of frame rails 38a, 38b having any shape and configuration.

The driven steerable suspension system 20 may couple the pair of wheels 24 to the vehicle frame 22 while allowing movement of the wheels 24 relative to the vehicle frame 22. More specifically, the driven steerable suspension system 20 allows for movement of the wheels 24 in a substantially vertical direction to prevent variations in the road surface from being directly transmitted to the vehicle frame 22 and the vehicle body (i.e., the driven steerable suspension system 20 provides a smooth ride for the vehicle frame 22 and the vehicle body). Furthermore, the driven steerable suspension system 20 allows the wheels 24 to be driven (i.e., propelled) typically by a prime mover, such as an internal combustion engine or an electric motor. Even further, the driven steerable suspension system 20 allows for articulation of the wheels 24 to steer the vehicle.

One having skill in the art will appreciate that the vehicle may include numerous wheels 24 and numerous driven steerable suspension systems 20 associated with the wheels 24.

As shown in FIGS. 1 and 2, the driven steerable suspension system 20 includes a subframe 40. The subframe 40 includes a first flank 42 and a second flank 44 spaced from the first flank 42. Each of the first and second flanks 42, 44 extend in a substantially planar configuration along a longitudinal axis L substantially parallel to one another for mounting along opposing outboard sides of the vehicle frame 22.

The driven steerable suspension system 20 further includes a first suspension assembly 46 coupled to the first flank 42 of the subframe 40 and a second suspension assembly 48 spaced from the first suspension assembly 46 and coupled to the second flank 44 of the subframe 40.

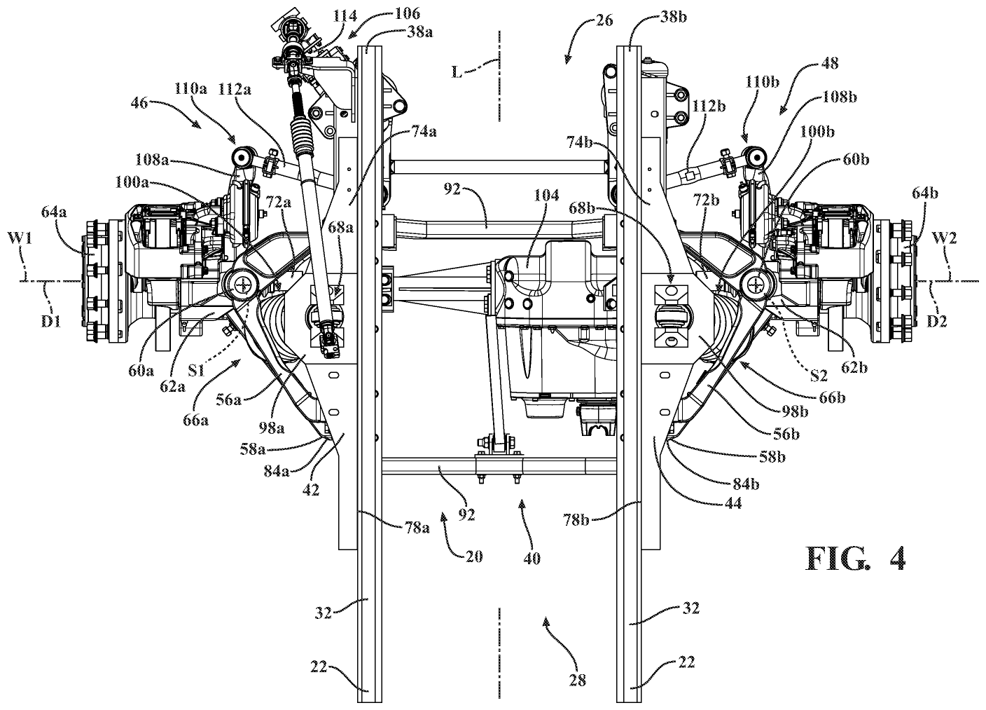

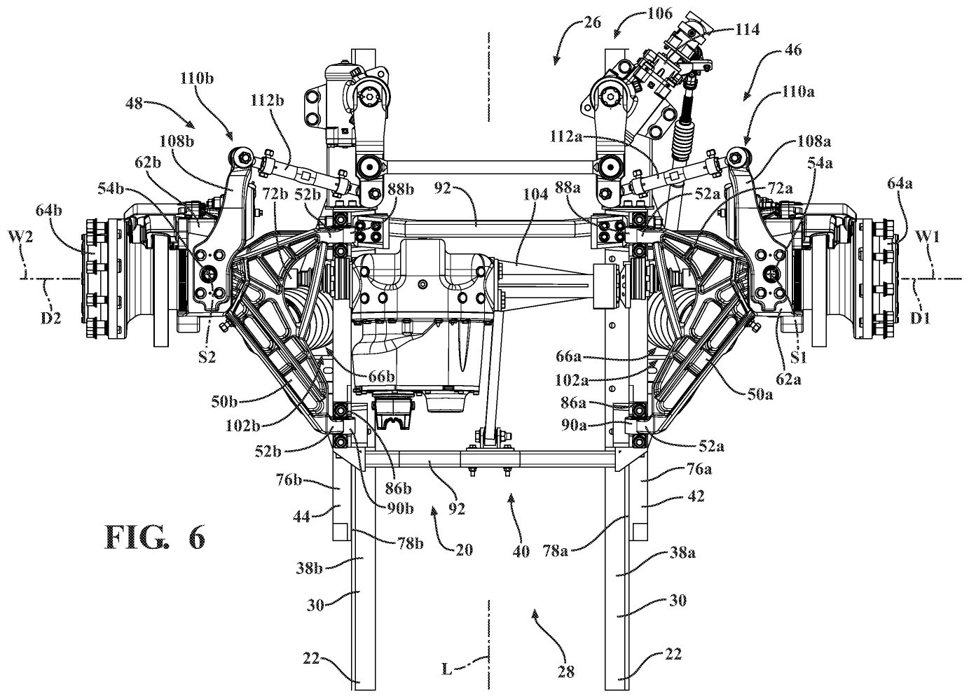

As shown in FIGS. 3-8, each of the first and second suspension assemblies 46, 48 include a lower control arm 50a, 50b extending between at least one lower inboard joint 52a, 52b and a lower outboard joint 54a, 54b, and an upper control arm 56a, 56b spaced from the lower control arm 50a, 50b and extending between at least one upper inboard joint 58a, 58b and an upper outboard joint 60a, 60b.

Each of the first and second suspension assemblies 46, 48 further include a steering knuckle 62a, 62b extending between and pivotally coupled to the lower outboard joint 54a, 54b of the lower control arm 50a, 50b and the upper outboard joint 60a, 60b of the upper control arm 56a, 56b along a steering axis S1, S2 transverse to the longitudinal axis L. The steering knuckle 62a, 62b is rotatable about the steering axis S1, S2 for turning one of the pair of wheels 24.

Each of the first and second suspension assemblies 46, 48 further include a wheel hub 64a, 64b rotatably coupled to the steering knuckle 62a, 62b along about a wheel axis W1, W2 for rotatably supporting one of the pair of wheels 24. The wheel axis W1, W2 intersects the steering axis S1, S2. Furthermore, each of the first and second suspension assemblies 46, 48 include a dampened biasing member 66a, 66b extending between a first end 68a, 68b pivotally mounted to the subframe 40 and a second end 70a, 70b pivotally mounted to the lower control arm 50a, 50b, and a drive axle 72a, 72b extending along a drive axis D1, D2 and rotatably coupled with the wheel hub 64a, 64b for rotating the wheel 24a, 24b. The second end 70a, 70b of the dampened biasing member 66a, 66b is mounted to the lower control arm 50a, 50b spaced from the drive axis D1, D2 to prevent contact between the drive axle 72a, 72b and the dampened biasing member 66a, 66b. The first end 68a, 68b of the dampened biasing member 66a, 66b is disposed above the at least one lower inboard joint 52a, 52b of the lower control arm 50a, 50b.

As described above, the first and second flanks 42, 44 may be mounted along opposing outboard sides of the vehicle frame 22, as shown in FIGS. 3 and 5. Each of the first and second flanks 42, 44 may have upper and lower surfaces 74a, 74b, 76a, 76b opposite one another and inner and outer surfaces 78a, 78b, 80a, 80b opposite another and extending between the upper and lower surfaces 74a, 74b, 76a, 76b. The inner surface may be configured to abut along the outboard side of the vehicle frame 22. More specifically, the first and second flanks 42, 44 may extend along and abut opposite side surfaces 34 of the vehicle frame 22. Each of the first and second flanks 42, 44 may have a substantially rectangular configuration each individually extending along one of the frame rails 38a, 38b of the vehicle frame 22. As such, the first and second flanks 42, 44 evenly distribute forces from the first and second suspension assemblies 46, 48 along their respective frame rails 38a, 38b and reduce stress points on the frame rails 38a, 38b. As shown in FIGS. 1, 2, 7, 8, and 10, the first and second flanks 42, 44 may include support ridges extending from the outer surface 80a, 80b of the first and second flanks 42, 44 to strengthen and/or stiffen the first and second flanks 42, 44. The support ridges limit the material needed to strengthen and/or stiffen the first and second flanks 42, 44 without adding additional weight.

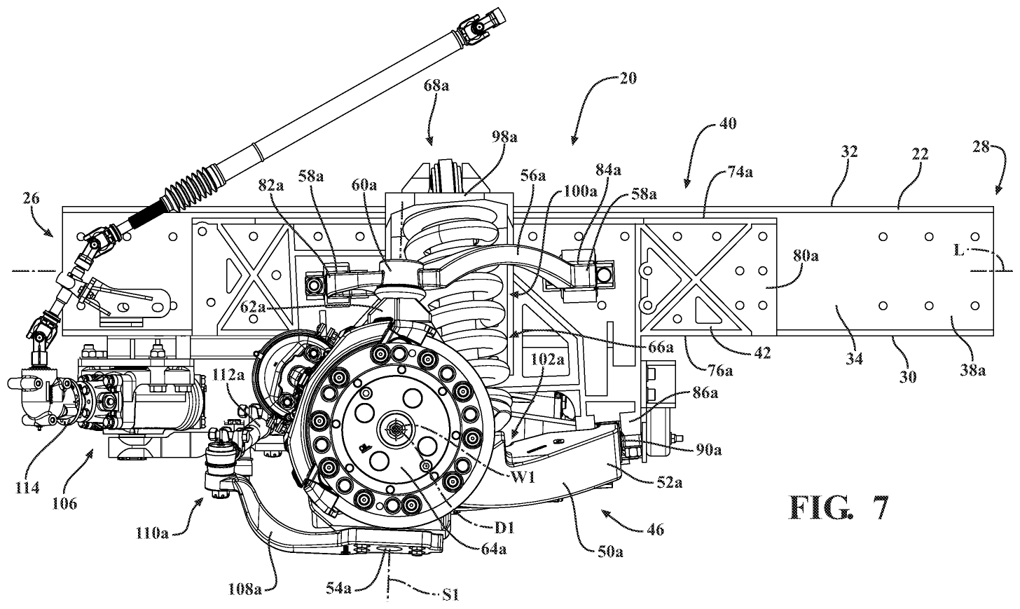

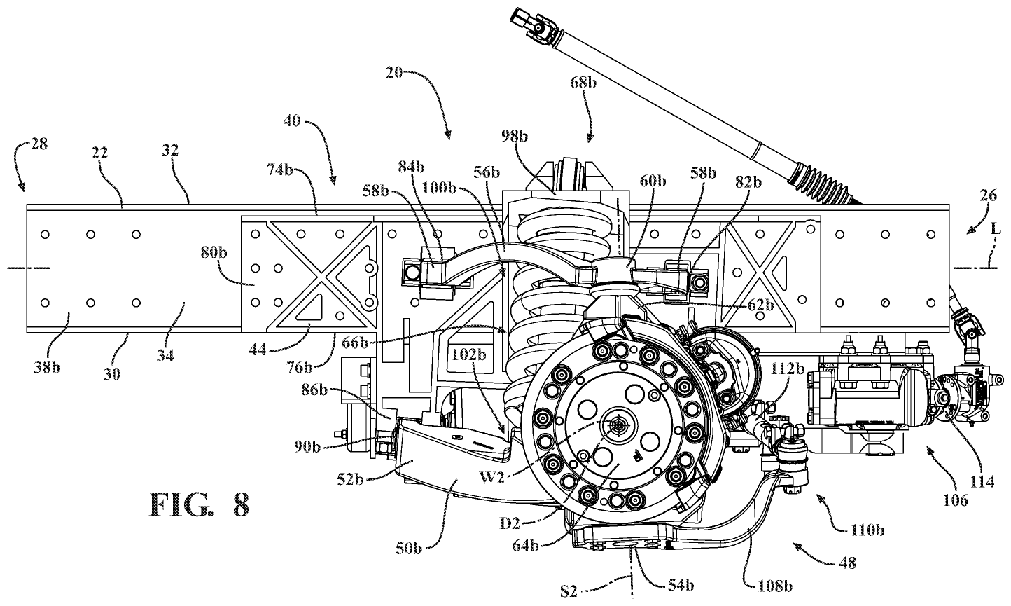

As shown in FIGS. 7 and 8, the at least one upper inboard joint 58a, 58b of the upper control arm 56a, 56b of each of the first and second suspension assemblies 46, 48 may be pivotally mounted to the outer surface 80a, 80b of the respective first and second flanks 42, 44, and spaced from each of the respective upper and lower surfaces 74a, 74b, 76a, 76b for centralizing force and torque exerted by each the upper control arms 56 on the respective first and second flanks 42, 44. The pivotal mounting of the at least one upper inboard joint 58a, 58b of the upper control arm 56a, 56b of each of the first and second suspension assemblies 46, 48 to the outer surface 80a, 80b of the first and second flanks 42, 44 aligns the vehicle frame 22 between the pair of wheels 24 and maximizes the vertical distance between the at least one lower inboard joint 52a, 52b of the lower control arm 50a, 50b and at least one upper inboard joint 58a, 58b of the upper control arm 56a, 56b in order to allow reduced force reaction into the frame rail 38a, 38b. The alignment of the vehicle frame 22 between the pair of wheels 24 lowers a ride height between the bottom surface 30 of the vehicle frame 22 and the road surface. The lowering of the ride height between the bottom surface 30 of the vehicle frame 22 and the road surface lowers the center of gravity of the vehicle, which reduces vehicle roll and improves vehicle handling.

The at least one upper inboard joint 58a, 58b of the upper control arm 56a, 56b of each of the first and second suspension assemblies 46, 48 may be further defined as a front upper inboard joint 82a, 82b and a rear upper inboard joint 84a, 84b spaced from the front inboard joint. Both of the front and rear upper inboard joints 82a, 82b, 84a, 84b may be pivotally mounted to the outer surface 80a, 80b of the respective first and second flanks 42, 44. Furthermore, the front and rear upper inboard joints 82a, 82b, 84a, 84b of the upper control arm 56a, 56b of each of the first and second suspension assemblies 46, 48 may be staggered along the outer surface 80a, 80b between the upper and lower surfaces 74a, 74b, 76a, 76b of the respective first and second flanks 42, 44 such that the front and rear upper inboard joints 82a, 82b, 84a, 84b are not axially aligned parallel to the longitudinal axis L. For example, as shown in FIGS. 7 and 8, the front upper inboard joint 82a, 82b of the upper control arm 56a, 56b may be lower than the rear upper inboard joint 84a, 84b. Staggering the front and rear upper inboard joints 82a, 82b, 84a, 84b of the upper control arm 56a, 56b alters the dynamics of the first and second suspension assemblies 46, 48, which may improve certain ride characteristics of the vehicle. For example, staggering the front and rear upper inboard joints 82a, 82b, 84a, 84b of the upper control arm 56a, 56b may reduce the squat of the vehicle (i.e., the tendency of the front end 26 of the vehicle to pitch up) and/or the dive of the vehicle (i.e., the tendency of the front end 26 of the vehicle to pitch down). Reducing squat and dive limits the movement of the center of gravity of the vehicle, which improves vehicle handling.

One having skill in the art will appreciate that the upper control arms 56 may have any number of joints pivotally coupled to the respective first and second flanks 42, 44. Furthermore, one having skill in the art will appreciate that the upper control arm 56a, 56b of each of the first and second suspension assemblies 46, 48 may be coupled to any portion of their respective flank.

As shown in FIGS. 1, 2, 7, and 8, each of the first and second flanks 42, 44 may have a pivot protrusion 86a, 86b extending below the lower surface 76a, 76b, with the lower control arm 50a, 50b of each of said first and second suspension assemblies 46, 48 pivotally mounted to the pivot protrusion 86a, 86b. Furthermore, the at least one lower inboard joint 52a, 52b of the lower control arm 50a, 50b may be further defined as a front lower inboard joint 88a, 88b and a rear lower inboard joint 90a, 90b spaced from the front lower inboard joint 88a, 88b. Accordingly, the protrusion of the first and second flanks 42, 44 may be further defined as two protrusions spaced from one another and extending below the lower surface 76a, 76b, with the front and rear lower inboard joints 88a, 88b, 90a, 90b of the lower control arm 50a, 50b of each of said first and second suspension assemblies 46, 48 pivotally mounted to the two pivot protrusions 86a, 86b.

Similar to the upper control arms 56 described above, the front and rear lower inboard joints 88a, 88b, 90a, 90b of the lower control arm 50a, 50b of each of the first and second suspension assemblies 46, 48 may be staggered such that the front and rear upper inboard joints 82a, 82b, 84a, 84b are not axially aligned parallel to the longitudinal axis L. As described above regarding the upper control arm 56a, 56b, staggering the front and rear lower inboard joints 88a, 88b, 90a, 90b of the lower control arm 50a, 50b alters the dynamics of the first and second suspension assemblies 46, 48, which may improve certain ride characteristics of the vehicle.

One having skill in the art will appreciate that the lower control arms 50 may have any number of joints pivotally coupled to the respective first and second flanks 42, 44. Furthermore, one having skill in the art will appreciate that the lower control arm 50a, 50b of each of the first and second suspension assemblies 46, 48 may be coupled to any portion of their respective flank. Furthermore, the lower control arm 50a, 50b of each of the first and second suspension assemblies 46, 48 may be coupled to any portion of the subframe 40.

As shown in FIGS. 1-6, the subframe 40 may further include a crossmember 92 extending between and connected to each of the first and second flanks 42, 44 for laterally supporting the first and second flanks 42, 44. The crossmember 92 may be disposed below the bottom surface 30 of the vehicle frame 22. Furthermore, the crossmember 92 may be further defined as a pair of crossmember 92s spaced from and substantially parallel to one another, with both of the pair of crossmembers 92 laterally supporting the first and second flanks 42, 44 at different positions on the first and second flanks 42, 44. One having skill in the art will appreciate that the crossmember 92 may be any number of crossmembers 92 for laterally supporting the first and second flanks 42, 44.

As shown in FIGS. 1, 3, and 5, the crossmember 92 may extend between the first and second flanks 42, 44 in a substantially U-shape configuration for wrapping the subframe 40 around the vehicle frame 22 and a powertrain of the vehicle. Said differently, the crossmember 92 may have a recessed configuration, with the crossmember 92 extending down toward the road surface. The recessed configuration allows for additional clearance above the crossmember 92 and between the frame rails 38a, 38b, which improves packaging of the vehicle. Furthermore, the recess of the crossmember 92 further lower the mass of the crossmember 92, which improves the center of gravity of the vehicle.

As shown in FIGS. 3, 5, 7, and 8, the upper control arm 56a, 56b may extend along a plane and the lower control arm 50a, 50b may extend along a plane spaced from the upper control arm 56a, 56b. The planes of the upper and lower control arms 56, 50 may be substantially parallel. As such, each of the upper and lower control arms 56, 50 may be coupled to the steering knuckles 62 at different locations. More specifically, the upper control arm 56a, 56b may be coupled to an upper portion of the steering knuckle 62a, 62b and the lower control arm 50a, 50b may be coupled to a lower portion of the steering knuckle 62a, 62b. The substantially parallel positioning of the upper and lower control arm 50a, 50b facilitates maintaining the wheel 24a, 24b in an upright configuration as the wheel 24a, 24b moves independent of the vehicle frame 22 due to changing road conditions.

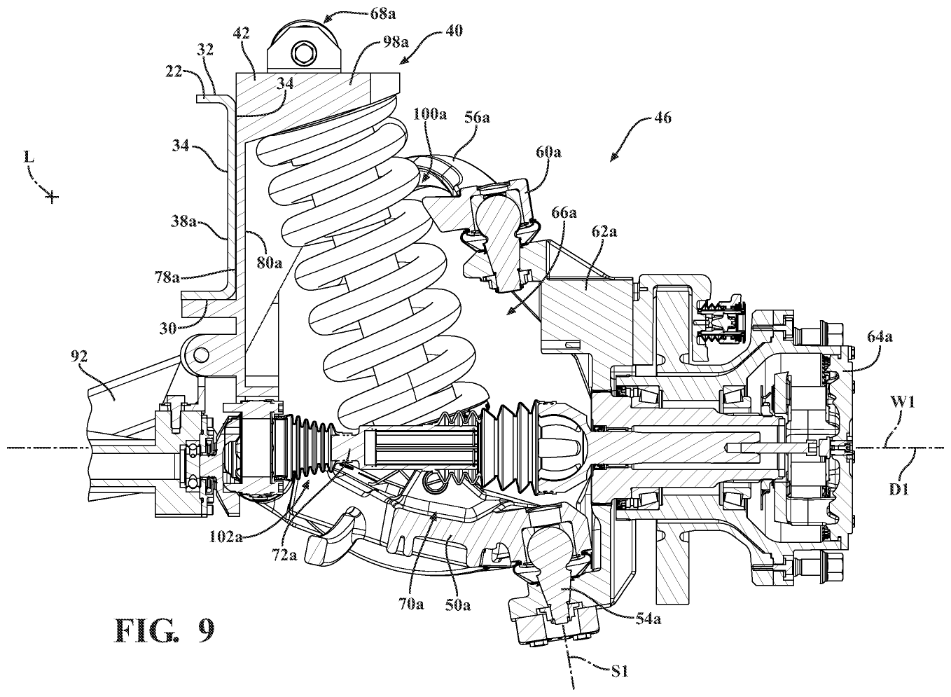

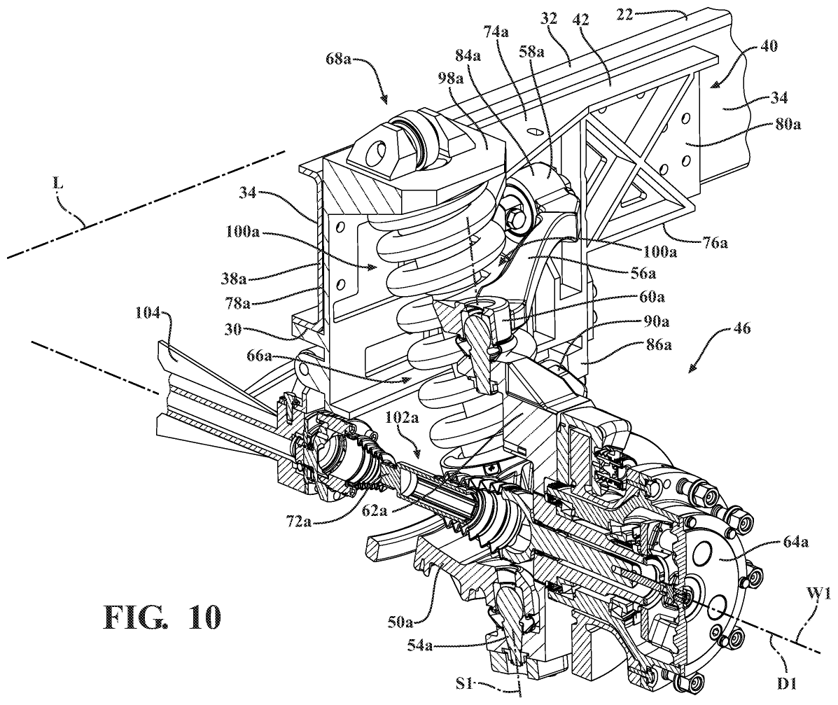

As shown in FIGS. 9 and 10, each of the dampened biasing members 66 may include a spring for cushioning the movement of the wheels 24 relative to the vehicle frame 22, and a shock absorber for limiting oscillation of the spring. The shock absorber may extend through the spring. Such a configuration is commonly referred to in the art as a coilover. One having skill in the art will appreciate that the dampened biasing member 66a, 66b may comprise any component capable of biasing and damping the movement of the wheels 24, including (but not limited to): airbags and hydrostruts.

As shown in FIGS. 2, 5, and 9, the first end 68a, 68b of the dampened biasing member 66a, 66b of each of the first and second suspension assemblies 46, 48 may be pivotally mounted to the respective first and second flanks 42, 44 above the at least one upper inboard joint 58a, 58b of the upper control arm 56a, 56b. Mounting the first end 68a, 68b of the dampened biasing member 66a, 66b above the at least one upper inboard joint 58a, 58b of the upper control arm 56a, 56b increases the length of the dampened biasing member 66a, 66b. The length of the dampened biasing member 66a, 66b correlates to the amount of travel of the wheel 24a, 24b in the vertical direction (i.e., the longer the dampened biasing member 66a, 66b, the greater the travel of the wheel 24a, 24b). Increasing the travel of the wheel 24a, 24b allows for a smoother ride over uneven road conditions. As such, mounting the first end 68a, 68b of the dampened biasing member 66a, 66b above the at least one upper inboard joint 58a, 58b of the upper control arm 56a, 56b increases the travel of the wheel 24a, 24b.

As shown in FIGS. 1-5 and 7-10, each of the first and second flanks 42, 44 may have a tower mount 98a, 98b extending above the upper surface 74a, 74b. The first end 68a, 68b of the respective dampened biasing member 66a, 66b may be pivotally mounted to the tower mount 98a, 98b. Positioning the tower mount 98a, 98b above the upper surface 74a, 74b further lengthens the dampened biasing member 66a, 66b and increases the travel of the wheel 24a, 24b.

Each of the first and second flanks 42, 44 may be a single integral component to rigidly support the first and second suspension assemblies 46, 48, respectively. Said differently, each of the first and second flanks 42, 44 may be formed of a common material and may be devoid of multiple components that are joined together, such as by mechanical fasteners, chemical bonding, welding, etc. As described above, the first and second flanks 42, 44 include the tower mount 98a, 98b and the pivot protrusion(s) 86a, 86b, which are also integral. The first and second flanks 42, 44 being a single integral component improves the strength of the first and second flanks 42, 44 by eliminating weak areas where components are joined. Although shown in the Figures as a single integral component, one having skill in the art will appreciate that the first and second flanks 42, 44 may each be formed of a plurality of components.

The upper control arm 56a, 56b may define a void 100a, 100b between the upper inboard and outboard joints, with the dampened biasing member 66a, 66b extending through the void 100a, 100b. In one embodiment shown in FIGS. 1, 2, 4, and 7-10, the upper control arm 56a, 56b may extend from the upper outboard joint 60a, 60b to each of the front and rear upper inboard joints 82a, 82b, 84a, 84b in a substantially V-shaped configuration. The void 100a, 100b is defined between front and rear upper inboard joints 82a, 82b, 84a, 84b. With the first end 68a, 68b of the dampened biasing member 66a, 66b pivotally mounted to the subframe 40 and the second end 70a, 70b pivotally mounted to the lower control arm 50a, 50b, the dampened biasing member 66a, 66b passes through the void 100a, 100b. The void 100a, 100b is sized such that pivoting of the upper control arm 56a, 56b relative to the subframe 40 does not result in contact between the dampened biasing member 66a, 66b and the upper control arm 56a, 56b. One have skill in the art will appreciate that the upper control arm 56a, 56b may have any suitable configuration for defining the void 100a, 100b.

Similar to the upper control arm 56a, 56b, the lower control arm 50a, 50b may define a void 102a, 102b between the lower inboard and outboard joints. In one embodiment shown in FIGS. 1, 2, 6, 9, and 10, the lower control arm 50a, 50b may extend from the lower outboard joint 54a, 54b to each of the front and rear lower inboard joints 88a, 88b, 90a, 90b in a substantially V-shaped configuration. The void 102a, 102b is defined between front and rear lower inboard joints 88a, 88b, 90a, 90b. The drive axle 72a, 72b may be between the front and rear lower inboard joints 88a, 88b, 90a, 90b. More specifically, the drive axle 72a, 72b may be disposed between the front and rear lower inboard joints 88a, 88b, 90a, 90b to depending on position of the lower control arm 50a, 50b. More specifically, pivoting of the lower control arm 50a, 50b relative to the subframe 40 in an upward direction brings the lower control arm 50a, 50b closer to the drive axle 72a, 72b. The void 102a, 102b is sized to accept the drive axle 72a, 72b as the lower control arm 50a, 50b pivots upwardly such that the lower control arm 50a, 50b does not contact the drive axle 72a, 72b. One have skill in the art will appreciate that the lower control arm 50a, 50b may have any suitable configuration for defining the void 102a, 102b.

As shown in FIGS. 3-6, the dampened biasing member 66a, 66b may be positioned between the first and second ends 68a, 68b, 70a, 70b in a non-vertical configuration. More specifically, the first and second flanks 42, 44 may lie vertically along the vehicle frame 22 and the upper and lower control arm 50a, 50b may extend outwardly away from the first and second flanks 42, 44. The second end 70a, 70b of the dampened biasing member 66a, 66b may be pivotally mounted to the lower control arm 50a, 50b adjacent the lower outboard joint 54a, 54b. Therefore, the dampened biasing member 66a, 66b may not be vertically aligned. The non-vertical configuration prevents the need for heavy horizontal support structures extending from the vehicle frame 22 (which would be needed to support a vertically oriented dampened biasing member 66a, 66b and its loads). Furthermore, the non-vertical configuration provides horizontal biasing and damping, which may be necessary during hard cornering of the vehicle. As such, the non-vertical configuration of the dampened biasing member 66a, 66b improves vehicle dynamics and handling. In one embodiment, the dampened biasing members 66 are angled between five and 25 degrees from the vertical orientation; however, one having skill in the art will appreciate that the dampened biasing members 66 may be positioned in any suitable non-vertical configuration.

The lower outboard joint 54a, 54b of the lower control arm 50a, 50b and the upper outboard joint 60a, 60b of the upper control arm 56a, 56b are each shown in the Figures as a single joint. However, one having skill in the art will appreciate that the lower outboard joint 54a, 54b and the upper outboard joint 60a, 60b may comprise any number of joints pivotally coupled to the steering knuckle 62a, 62b. Furthermore, the lower outboard joint 54a, 54b of the lower control arm 50a, 50b and the upper outboard joint 60a, 60b of the upper control arm 56a, 56b may be further defined as a ball joint to facilitate pivoting of the steering knuckle 62a, 62b about the steering axis S1, S2 and transverse to the steering axis S1, S2 for turning one of the pair of wheels 24 and moving the one of the pair of wheels 24 vertically relative to the subframe 40, as shown in FIGS. 9 and 10.

As shown in FIGS. 3-6, 9, and 10, the driven steerable suspension may further include a differential 104, with the drive axle 72a, 72b rotatably coupled to and driven by the differential 104. In one embodiment, the differential 104 is fixed to the subframe 40, with the drive axle 72a, 72b articulable relative the differential 104 for facilitating driving the wheel 24a, 24b as the wheel 24a, 24b moves relative to the subframe 40. In such a configuration, each of the drive axles 72 are commonly referred to in the art as half-shafts. The drive axles 72 extending from opposing sides of the differential 104, with the drive axles 72 individually coupled their respective wheel hub 64a, 64b. The differential 104 may be mounted to at least one of the crossmembers 92 to fix the differential 104 to the subframe 40. One having skill in the art will appreciate that the differential 104 may be fixed to the subframe 40 in any suitable manner. Furthermore, the differential 104 may be fixed to the vehicle frame 22. As yet another alternative, the differential 104 may be suspended by dampened members, also known as compliant bushings.

The differential 104 is configured to receive rotary motion from a power source (e.g. from a powertrain of the vehicle) and transmit the rotary motion to the wheels 24 while allowing the wheels 24 to rotate at different speeds, such as when the vehicle is turning. As described above, the drive axles 72 may be articulable. More specifically, each of the drive axles 72 may be capable of articulating at the coupling of the drive axles 72 to the differential 104 and at the coupling of the drive axles 72 to the wheel hubs 64. Such articulation allows for movement of the wheels 24 without moving the differential 104. In such a configuration, the driven steerable suspension system 20 is commonly referred to in the art as comprising an independent suspension.

The differential 104 may have an input (which receives the rotary motion from the power source) that is offset from a center-line of the vehicle for packaging and clearance purposes. In such a configuration, the differential 104 may be elongated between the wheel hubs 64 such that the drive axles 72 are equal length. Elongating the differential 104 and maintaining equal length of the drive axles 72 reduces a phenomena commonly referred to in the art as torque-steer. Torque-steer generally refers to a tendency for the vehicle to pull in one direction as the wheels 24 are driven and is commonly a result of unequal drive axle lengths.

As shown in FIGS. 1, 3, and 6, the driven steerable suspension system 20 may further include a steering system 106 coupled to both of the steering knuckles 62 to facilitate articulation of the wheels 24 about the steering axes S1, S2 for turning the vehicle. More specifically, the steering system 106 may facilitate articulation of the wheels 24 based on input from an operator (via a steering wheel) or an autonomous computer system. However, one having skill in the art will appreciate that the steering system 106 may be activated through any suitable input.

The steering knuckle 62a, 62b of each of the first and second suspension assemblies 46, 48 may include a steering arm 108a, 108b extending substantially perpendicular to the wheel axis W1, W2 to a distal end 110a, 110b spaced from the wheel axis W1, W2, with the steering system 106 coupled to the distal end 110a, 110b of the steering arm 108a, 108b and exerting force transverse to the steering arm 108a, 108b for articulating the wheel 24a, 24b about the steering axis S1, S2. Furthermore, the steering system 106 may include a tie rod 112a, 112b extending to and coupled with the distal end 110a, 110b of the steering arm 108a, 108b. More specifically, the steering system 106 may include two tie rods 112a, 112b individually extending to and coupled with the distal end 110a, 110b of the steering arm 108a, 108b of one of the steering knuckles 62. The tie rod 112a, 112b may generally move linearly along the longitudinal axis of the tie rod 112a, 112b. As such, the tie rod 112a, 112b exerts a moment on the steering knuckle 62a, 62b through the steering arm 108a, 108b to articulate the steering knuckle 62a, 62b about the steering axis S1, S2.

The steering system 106 may include a steering mechanism 114 that converts rotational motion (from the driver operated steering wheel) into linear motion of the tie rod 112a, 112b. Examples of the steering mechanism 114 include (but are not limited to): rack and pinion, worm and sector, and recirculating ball.

As shown in FIG. 1, the steering system 106 may be positioned substantially in front of the drive axle 72a, 72b, toward the front end 26 of the vehicle. Likewise, the pair of dampened biasing members 66 may be positioned substantially behind the steering knuckles 62, toward the rear end 28 of the vehicle. As such, the at least lower one inboard joint may be disposed between the drive axle 72a, 72b and the tie rod 112a, 112b for preventing contact between the drive axle 72a, 72b and the tie rod 112a, 112b during articulation of the steering knuckle 62a, 62b about the steering axis S1, S2, as shown in FIGS. 1, 4, and 6. Furthermore, the upper and lower control arms 56, 50 of each of the first and second suspension assemblies 46, 48 may be offset such that the upper and lower control arms 56, 50 are coupled to the subframe 40 between the steering system 106 and the dampened biasing members 66 to prevent contact of the upper and lower control arms 56, 50 with the dampened biasing members 66 and the steering system 106.

The driven steerable suspension system 20 as described herein may have a modular configuration. Said differently, the driven steerable suspension system 20 may be easily adapted to various vehicles by simply mounting the subframe 40 to the vehicle frame 22. In doing so, the driven steerable suspension system 20 may be assembled to various vehicles through little to no modification of the vehicle. The modular configuration allows for use of the driven steerable suspension system 20 across various vehicle platforms, which improves manufacturing efficiency. Furthermore, the modular configuration allows for quicker repairs to broken components of the driven steerable suspension system 20 by simply replacing the entire driven steerable suspension system 20, which leads to less downtime of the vehicle.

The invention has been described in an illustrative manner, and it is to be understood that the terminology that has been used is intended to be in the nature of words of description rather than of limitation. As is now apparent to those skilled in the art, many modifications and variations of the subject invention are possible in light of the above teachings. It is, therefore, to be understood that within the scope of the appended claims, wherein reference numerals are merely for convenience and are not to be in any way limiting, the invention may be practiced otherwise than as specifically described.

1. A driven steerable suspension system for a vehicle, with the driven steerable suspension system mounted to a vehicle frame of the vehicle and a pair of wheels of the vehicle; said driven steerable suspension system comprising:
a subframe comprising a first flank and a second flank spaced from said first flank, with each of said first and second flanks extending in a substantially planar configuration along a longitudinal axis substantially parallel to one another for mounting along opposing outboard sides of the vehicle frame;
a first suspension assembly coupled to said first flank of said subframe and a second suspension assembly spaced from said first suspension assembly and coupled to said second flank of said subframe, with each of said first and second suspension assemblies comprising:
a lower control arm extending between at least one lower inboard joint and a lower outboard joint;
an upper control arm spaced from said lower control arm and extending between at least one upper inboard joint and an upper outboard joint;
a steering knuckle extending between and pivotally coupled to said lower outboard joint of said lower control arm and said upper outboard joint of said upper control arm along a steering axis transverse to said longitudinal axis, with said steering knuckle rotatable about said steering axis for turning one of the pair of wheels;
a wheel hub rotatably coupled to said steering knuckle along and about a wheel axis for rotatably supporting one of the pair of wheels, with said wheel axis intersecting said steering axis;
a dampened biasing member extending between a first end pivotally mounted to said subframe and a second end pivotally mounted to said lower control arm; and
a drive axle extending along a drive axis and rotatably coupled with said wheel hub for rotating the wheel, with said second end of said dampened biasing member mounted to said lower control arm spaced from said drive axis to prevent contact between said drive axle and said dampened biasing member;
wherein said first end of said dampened biasing member is disposed above said at least one lower inboard joint of said lower control arm.

2. The driven steerable suspension system as set forth in claim 1, wherein each of said first and second flanks are a single integral component to rigidly support said first and second suspension assemblies, respectively.

3. The driven steerable suspension system as set forth in claim 1, wherein each of said first and second flanks have upper and lower surfaces opposite one another and inner and outer surfaces opposite one another and extending between said upper and lower surfaces, with said inner surface configured to abut the outboard side of the vehicle frame.

4. The driven steerable suspension system as set forth in claim 3, wherein said at least one upper inboard joint of said upper control arm of each of said first and second suspension assemblies is pivotally mounted to said outer surface of said respective first and second flanks, and spaced from each of said respective upper and lower surfaces for centralizing force and torque exerted by each of said upper control arms on said respective first and second flanks.

5. The driven steerable suspension system as set forth in claim 4, wherein said first end of said dampened biasing member of each of said first and second suspension assemblies is pivotally mounted to said respective first and second flanks above said at least one upper inboard joint of said upper control arm.

6. The driven steerable suspension system as set forth in claim 5, wherein each of said first and second flanks have a tower mount extending above said upper surface, with said first end of said respective dampened biasing member pivotally mounted to said tower mount.

7. The driven steerable suspension system as set forth in claim 4, wherein said at least one upper inboard joint of said upper control arm of each of said first and second suspension assemblies is further defined as a front upper inboard joint and a rear upper inboard joint spaced from said front inboard joint, with both of said front and rear upper inboard joints pivotally mounted to said outer surface of said respective first and second flanks.

8. The driven steerable suspension system as set forth in claim 7, wherein said front and rear upper inboard joints of said upper control arm of each of said first and second suspension assemblies are staggered along said outer surface between said upper and lower surfaces of said respective first and second flanks such that said front and rear upper inboard joints are not axially aligned parallel to said longitudinal axis.

9. The driven steerable suspension system as set forth in claim 1, wherein said subframe further includes a crossmember extending between and connected to each of said first and second flanks for laterally supporting said first and second flanks.

10. The driven steerable suspension system as set forth in claim 9, wherein said crossmember extends between said first and second flanks in a substantially U-shape configuration for wrapping said subframe around the vehicle frame.

11. The driven steerable suspension system as set forth in claim 3, wherein each of said first and second flanks have a pivot protrusion extending below said lower surface, with said lower control arm of each of said first and second suspension assemblies pivotally mounted to said pivot protrusion.

12. The driven steerable suspension system as set forth in claim 1, wherein said upper control arm defines a void between said upper inboard and outboard joints, with said dampened biasing member extending through said void.

13. The driven steerable suspension system as set forth in claim 1, wherein said dampened biasing member is positioned between said first and second ends in a non-vertical configuration.

14. The driven steerable suspension system as set forth in claim 1, wherein said lower outboard joint of said lower control arm and said upper outboard joint of said upper control arm are further defined as a ball joint to facilitate pivoting of said steering knuckle about said steering axis and transverse to said steering axis for turning one of the pair of wheels and moving the one of the pair of wheels vertically relative to said subframe.

15. The driven steerable suspension system as set forth in claim 1, wherein said at least one lower inboard joint of said lower control arm is further defined as a front lower inboard joint and a rear lower inboard joint spaced from said front lower inboard joint, with said drive axle between said front and rear lower inboard joints.

16. The driven steerable suspension system as set forth in claim 1, further including a differential, with said drive axle rotatably coupled to and driven by said differential.

17. The driven steerable suspension system as set forth in claim 16, wherein said differential is fixed to said subframe, with said drive axle articulable relative to said differential for facilitating driving the wheel as the wheel moves relative to said subframe.

18. The driven steerable suspension system as set forth in claim 1, further including a steering system coupled to both of said steering knuckles to facilitate articulation of the wheels about said steering axes for turning the vehicle.

19. The driven steerable suspension system as set forth in claim 18, wherein said steering knuckle of each of said first and second suspension assemblies includes a steering arm extending substantially perpendicular to said wheel axis to a distal end spaced from said wheel axis, with said steering system coupled to said distal end of said steering arm and exerting force transverse to said steering arm for articulating the wheel about said steering axis.

20. The driven steerable suspension system as set forth in claim 19, wherein said steering system includes a tie rod extending to and coupled with said distal end of said steering arm, with said at least one lower inboard joint disposed between said drive axle and said tie rod for preventing contact between said drive axle and said tie rod during articulation of said steering knuckle about said steering axis.
